(19) United States
(12) Patent Application Publication
(10) Pub. No.: US 2021/0064140 A1
(43) Pub. Date: Mar. 4, 2021

(54) Terminal and Methods for Dynamic Switching between Point-Of-Sale (POS) Modes of Operation and Self-Service (SS) Modes of Operation

(71) Applicant: NCR Corporation, Atlanta, GA (US)

(72) Inventors: Gregory Scott Egan, Flowery Branch, GA (US); Gary C. Dalton, Lawrenceville, GA (US)

(21) Appl. No.: 16/555,096

(22) Filed: Aug. 29, 2019

(51) Int. Cl. G06F 3/01; G06F 1/16; G06Q 20/20

(52) U.S. Cl. CPC G06F 3/017; G06Q 20/204; G06F 1/1694

(57) ABSTRACT

A transaction terminal includes a rotatable display. When the display is moved from a first orientation to a second orientation, an Operating System (OS) even is raised and a controller is processed. The controller dynamically changes a current mode of operation for the terminal having first content, first interfaces, and first operations to a different mode of operation for the terminal having second content, second interfaces, and second operations.

### BACKGROUND

Retailers continue to struggle with rising labor costs and a tight labor market. One potential solution is for the retailers to provide more Customer Self-Ordering (CSO) hardware and related software technologies, which would permit retailers to provide customer with self-service checkout options, such that existing employees of an establishment are able to focus on other tasks and do not have to be solely dedicated to handling customer traffic at the establishment.

Because profit margins are so thin in Quick Service Restaurants (QSRs), these businesses are reluctant to invest in capital expenditures associated with purchasing CSO hardware and software. Any new CSO equipment would require physical space to house the equipment and often available physical space is at a premium. In some cases, the retailers would have to retrofit the layout of their stores to accommodate CSO equipment. Still further, installation of the CSO equipment would disrupt the business and may have adverse impacts on customer sales during such period.

### SUMMARY

In various embodiments, a terminal and methods for dynamic switching between Point-Of-Sale (POS) modes of operation and Self-Service modes of operation are presented.

According to an embodiment, a method for dynamically switching a terminal from a first mode of operation to a second mode of operation is presented. Specifically, and in one aspect, a change in orientation of a display associated with a transaction terminal is detected as changing from a first orientation to a second orientation. The transaction terminal is dynamically changed from a first mode of operation to a second mode of operation based on detection of the second orientation.

### BRIEF DESCRIPTION OF THE DRAWINGS

FIG. 1A is a diagram of a backside view of a terminal that dynamically switches between modes of operation, according to an example embodiment.

FIG. 1B is a diagram of a frontside view of a terminal that dynamically switches between modes of operation, according to an example embodiment.

FIG. 1C is a diagram of a side view of a mounting brace for the terminal, according to an example embodiment.

FIG. 1D is a diagram of a transparent view of a backside of the terminal illustrating internal components of the terminal, according to an example embodiment.

FIG. 1E is a diagram of a transparent view of a base of the terminal illustrating internal connection ports and cabling of the terminal, according to an example embodiment.

FIG. 2 is a diagram of a method for dynamically switching a transaction terminal from a first mode of operation to a second mode of operation, according to an example embodiment.

FIG. 3 is a diagram of another method for dynamically switching a transaction terminal from a first mode of operation to a second mode of operation, according to an example embodiment.

### DETAILED DESCRIPTION

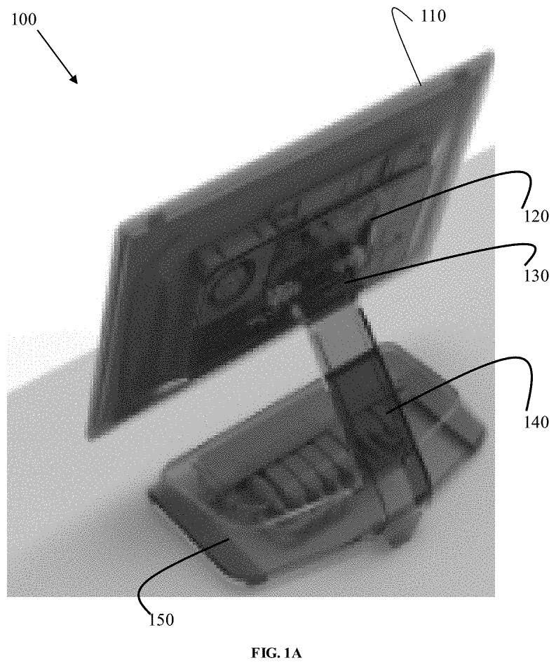

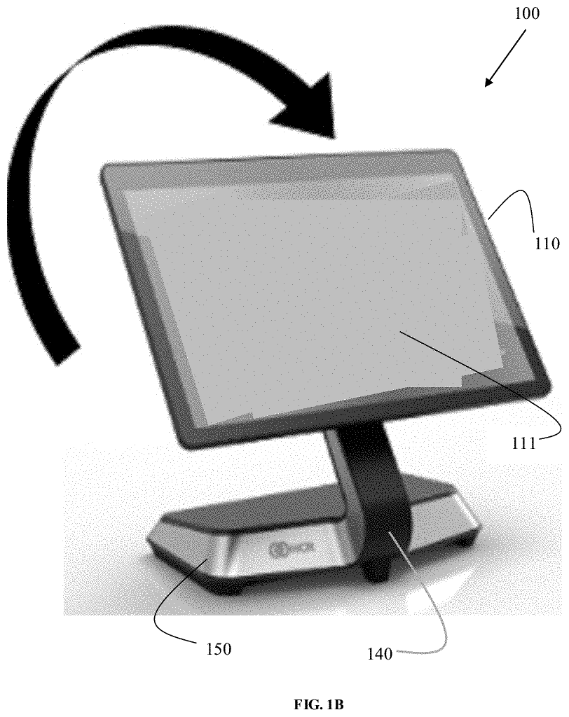

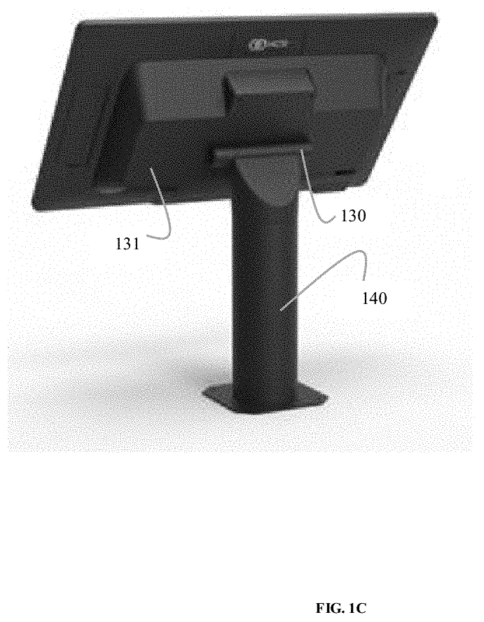

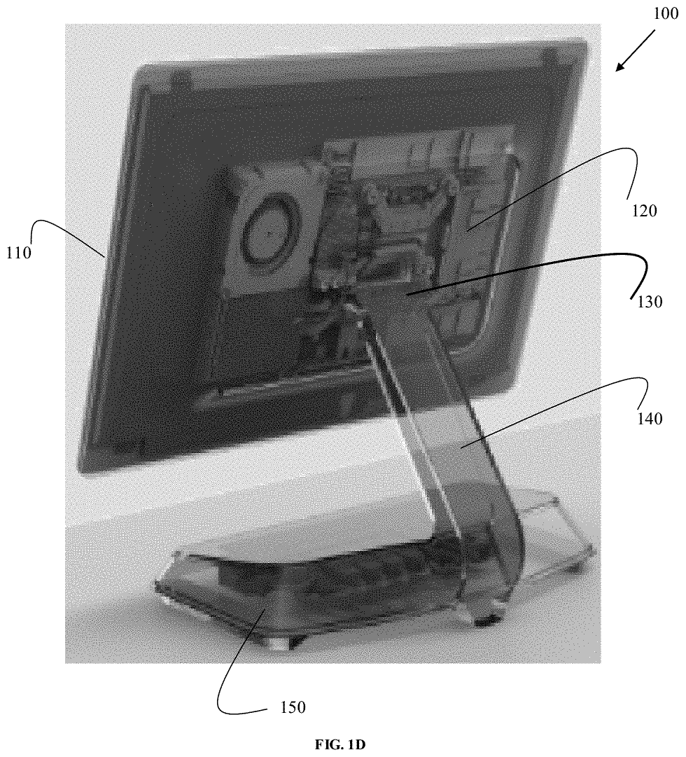

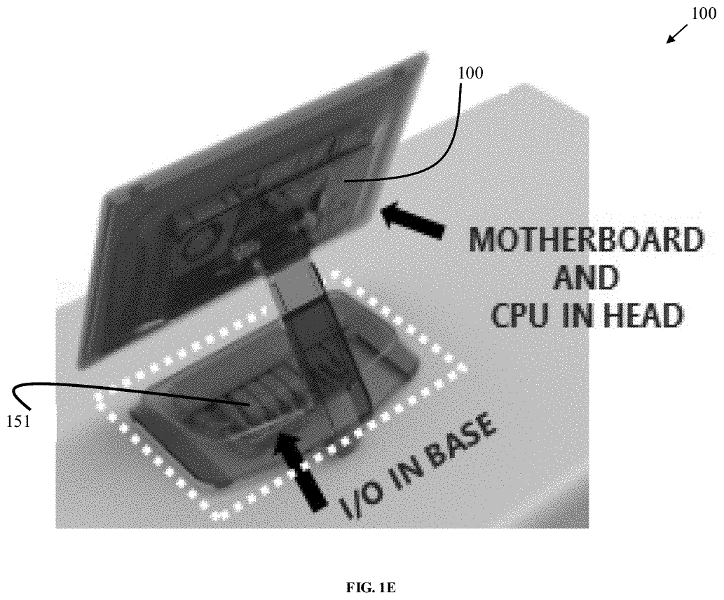

FIG. 1A is a diagram of a backside view of a transaction terminal 100 that dynamically switches between modes of operation, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of a transaction terminal that dynamically switches between an active mode of operation (first mode) to a new mode of operation (second mode) as presented herein and below.

The transaction terminal 100 includes a display 110, a motherboard 120 mounted on the back of the display within a housing, a display orientation pivot lever 130 attached to a mounting brace 140, and a display base 150.

The mounting brace 140 is hollow, such that cables and bus connections needed between the motherboard 120 for power and connectivity are hidden from view, which also improves safety since such cables and bus wires are encased within the inside of the mounting brace and not exposed.

Peripheral connection ports (shown as 151 in FIG. 1E) are enchased with a housing associated with the display base 150.

As is evidenced by the FIGS., the transaction terminal 100 includes a small environmental footprint that occupies a smaller amount of space that conventional transaction terminals.

In an embodiment, the display 110 is between a 15 inch and 21.5-inch touchscreen display. The base 150 can range between a width of approximately 293 mm and approximately 188 mm in length or a width of approximately 189 mm in width and approximately 160 mm in length. It is to be appreciated that other dimensions are foreseeable and can be used with the various embodiments of the transaction terminal 110.

In an embodiment, the motherboard 120 includes and supports: a Coffee Lake® 8th generation T-Series chip set, an 8 GB to 32 GB of DDR4-2400 memory with 2 available expansion slots, powered Universal Serial Bus (USB) connections: Input/Output (I/O) 3X12V+1X24V; powered serial connections: 1XRJ50+1XDB89, 4XRJ12+2XRJ45; video connections: DisplayPort® and USB-C; storage: M.2 Solid State Drive (SSD) or NVMe SSD, RAID: M.2 SSD.

It is to be appreciated that other features may be provided as well such as 128 GB memory, Compact Disc (CD) ports, etc. In fact, a variety of different resources and configurations are conceivable with the terminal 100. As one example, the terminal 100 may include an integrated front-facing camera, contact-based or contactless card readers, etc.

In an embodiment, display 110 may also include an integrated magnetic card or chip card reader and corresponding slot for receiving customer payment (either through a card swipe along an edge of the display 110 or through insertion of a card into a card chip reader integrated into the display 110). In an embodiment, the display 110 includes a contactless card reader (Near Field Communication (NFC), Bluetooth®, etc.) for receiving and processing customer payment.

Notably, the display orientation pivot lever 130 attached to the mounting brace 140 permits the display 110 (which includes the motherboard 120 on its backside (side without the touchscreen display 111 (shown in the FIG. 1B))) to be rotated or flipped from a first orientation shown in the FIG. 1A to a second orientation shown in the FIG. 1B and illustrated by the arrow).

The motherboard 120 also includes an integrated accelerometer or an integrated gyroscope. The Operating System (OS) that executes on the processor of the motherboard 120 includes an OS hook, such that when the orientation is changed from the orientation shown in the FIG. 1A to the orientation shown in the FIG. 1B a mode switching set of executable instructions is initiated on the motherboard 120. The mode switching set of executable instructions (hereinafter just mode switcher) suspends a current active mode of operation for the terminal 100 and places the terminal 100 in a different active mode of operation.

In an embodiment, the accelerometer or the gyroscope are external to the motherboard 120 and attached somewhere on the display 110 and/or on the pivot lever 130.

For example, the display 110 is in the first orientation shown in the FIGS. 1A and 1s situated on a countertop of a QSR where a cashier is operating the terminal 100 in a POS mode of operation (cashier is taking a customer order or checking the customer out or a store with purchases). The cashier's shift ends and is leaving the store/restaurant and the terminal 100 is to operate as a Self-Service Terminal (SST) in a Self-Service (SS) mode of operation. The cashier simply rotates/flips the display 110 from an orientation facing the cashier (as shown in the FIG. 1A) to a new orientation facing where customers would approach the terminal 100. The accelerometer detects the movement and change in orientation of the display 110, which the OS hook is provided by the OS causing the mode switcher to execute on the processor of the motherboard 120. The mode switcher, then executes a transaction manager set of executable instructions (hereinafter just “transaction manager”) causing the user-interfaces and operations to change on the terminal 100 to ones associated with the SS mode of operation. Any customer approaching the terminal 100 can then perform self-ordering (in the case of a restaurant) or self-checkout in the case of a retail store.

The accelerometer detects rotation, twists, and movements of the motherboard 120 where the accelerometer is embedded and raises an event corresponding to a display orientation change. The event is passed from the OS to the OS hook. The OS hook initiates the transaction manager.

This is all seamless and automatic and this is different from conventional approaches that merely re-orient content on a display to a new orientation based on a change in orientation. This technique changes the programs and the interfaces associated with a first mode of operation of the terminal 100 to one or more different programs and different interfaces associated with a different mode of operation for the terminal 100. That is conventional approaches do not alter the mode of operation of the devices; rather, the conventional approaches merely reformat information that was already being displayed on the conventional devices when the change in orientation was detected.

FIG. 1C illustrates a side view of the display orientation pivot lever 130 attached to a mounting brace 140. A bracket 131 is detachable and attachable housing to the back of the display 110 for securing the display 110 in a vertical orientation as shown in the FIGS. Any wires (including power cord) fit through an aperture in the center of the bracket 131 and can be fed through a top of the mounting brace 140. The bracket encases the motherboard 120 and any other integrated peripherals situated on the back of the display 110. The wires run from connections to the motherboard 120 and integrated peripherals through the aperture of the arm/pole brace 140 to the base 150 where they are connected to a peripheral or device docket station or port interface 151 for such things as power, network connections, and peripheral connections.

FIG. 1D provides a see-through or transparent view into backside of the display 120 to illustrate the motherboard 120 and any integrated card reader, the hole through the mounting brace 140 where wires would run.

FIG. 1E provides a see-through or transparent view into the housing of the base 150. A docket station or I/O base 151 is located inside the housing of the base 150 for making peripheral and network connections between the motherboard 120 and peripheral devices/network connections.

In this way, the wiring is encased within the brace 140 and the base 150.

The transaction terminal 100 combined with the mode switcher or controller allows an operator to continually switch a current mode of operation between a POS mode of operation and a SS mode of operation (may also be referred to as kiosk mode of operation herein and below). This does not require the establishment (QSR, restaurant, hotel, retail store) to perform rewiring and any retrofitting to accommodate a SS solution. The SS solution and cashier-assisted solution and performed within the same retail space and on the same transaction terminal 100. The terminal 100 also permits the establishment to utilize the terminal 100 in a kiosk mode when staff is unavailable to operate the terminal 100 and utilize the same terminal 100 in a cashier-assisted (POS) mode of operation when staff is present. This is an optimal utilization of the investment that the establishment has in the terminal 100. Still further, typical kiosk installations require new network wiring, power outlets, and space; this is unnecessary with the terminal 100 because all these are shared by one terminal 100 that dynamically switched between POS modes of operation and kiosk modes of operation through reorientation (flipping) the display 110 of the terminal 100.

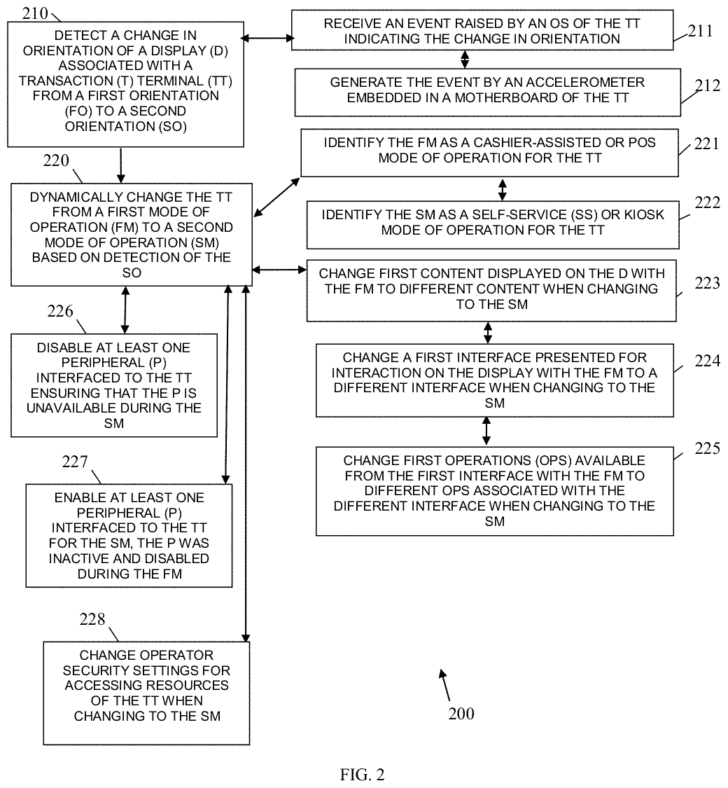

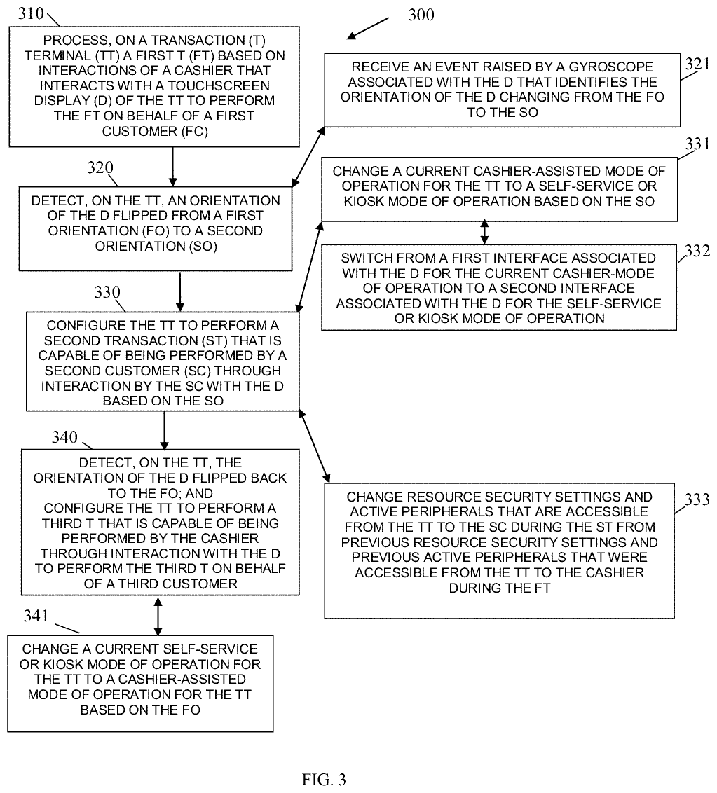

These and other embodiments are now discussed with reference to the FIGS. 2-3.

FIG. 2 is a diagram of a method 200 for dynamically switching a transaction terminal from a first mode of operation to a second mode of operation, according to an example embodiment. The software module(s) that implements the method 200 is referred to as a “terminal operating mode controller.” The terminal operating mode controller is implemented as executable instructions programmed and residing within memory and/or a non-transitory computer-readable (processor-readable) storage medium and executed by one or more processors of a device. The processor(s) of the device that executes the terminal operating mode controller are specifically configured and programmed to process the terminal operating mode controller. The terminal operating mode controller may or may not have access to one or more network connections during its processing. The network connections can be wired, wireless, or a combination of wired and wireless.

In an embodiment, the device that executes the transaction terminal 100.

In an embodiment, the terminal operating mode controller performs, inter alia, the processing described above with respect to the mode switcher (as discussed with FIGS. 1A-1E above).

At 210, the terminal operating mode controller detects a change in orientation of a display associated with a transaction terminal from a first orientation to a second orientation.

In an embodiment, at 211, the terminal operating mode controller receives an event raised by an OS of the transaction terminal that indicates the change in orientation was detected or was made by an operator of the transaction terminal.

In an embodiment, at 212, an accelerometer or gyroscope embedded in a motherboard of the transaction terminal generates the event detected by the OS. In an embodiment, an OS hook is provided to detect and process the hook. In an embodiment, the OS hook initiates the terminal operating mode controller for processing on the transaction terminal upon receipt of the event from the OS. In an embodiment, the motherboard of the transaction terminal is integrated into a housing of the display.

At 220, the terminal operating mode controller dynamically changes the transaction terminal from a first mode of operation to a second mode of operation based on detection of the second orientation.

In an embodiment, of 221, the terminal operating mode controller identifies the first mode as a cashier-assisted or POS mode of operation for the transaction terminal (a cashier performs the transaction on behalf of a customer—the transaction can be an order (food or goods or services), to check-in to an establishment, and/or to purchase items from the establishment).

In an embodiment of 221 and at 222, the terminal operating mode controller identifies the second mode of operation as a SS or kiosk mode of operation for the transaction terminal (a customer performs the transaction with no assistance from a cashier).

In an embodiment, at 223, the terminal operating mode controller changes first content displayed on the display with the first mode of operation to different content when changing from the first mode to the second mode.

In an embodiment of 223 and at 224, the terminal operating mode controller changes a first interface presented for interaction on the display with the first mode of operation to a different interface that is associated with the display when changing from the first mode to the second mode.

In an embodiment of 224 and at 225, the terminal operating mode controller changes first operations available from the first interface with the first mode to different operations associated with the different interface when changing from the first mode to the second mode.

In an embodiment, at 226, the terminal operating mode controller disables at least one peripheral interfaced to the transaction terminal ensuring that the peripheral is unavailable and inaccessible during the second mode of operation. For example, a peripheral cash drawer that is operated by a cashier in the first mode of operation is made inaccessible to a customer in the second mode of operation. It is noted that other peripherals may be disabled as well beyond just the cash drawer.

In an embodiment, at 227, the terminal operating mode controller enables at least one peripheral interfaced to the transaction terminal for the second mode of operation. The peripheral was inactive and disabled during the first mode of operation. For example, a peripheral front-facing camera integrated into the front of the display may be enabled to capture an image of the customer and such camera was disabled when the cashier was operating the transaction terminal. Again, this can be other peripherals beyond just the front-facing integrated camera.

In an embodiment, at 228, the terminal operating mode controller changes operator security settings for accessing resources of the transaction terminal when changing from the first mode to the second mode. For example, access to certain files, operations, peripherals, etc. may be restricted when the terminal is in the second mode or a SS or kiosk mode and unrestricted when the terminal is in the first mode or cashier-assisted or POS mode of operation.

FIG. 3 is a diagram of another method 300 for dynamically switching a transaction terminal from a first mode of operation to a second mode of operation, according to an example embodiment. The software module(s) that implements the method 300 is referred to as a “operating mode switcher.” The operating mode switcher is implemented as executable instructions programmed and residing within memory and/or a non-transitory computer-readable (processor-readable) storage medium and executed by one or more processors of a device. The processors that execute the operating mode switcher are specifically configured and programmed to process the operating mode switcher. The operating mode switcher may or may not have access to one or more network connections during its processing. The network connections can be wired, wireless, or a combination of wired and wireless.

In an embodiment, the device that executes the operating mode switcher is a transaction terminal 100.

In an embodiment, the operating mode switcher is all or some combination of: mode switcher discussed with the FIGS. 1A-1E and/or the method 200.

The operating mode switcher presents another and, in some ways, enhanced processing perspective to that which was described above with the FIG. 2.

At 310, the operating mode switcher processes a first transaction on a transaction terminal based on interactions of a cashier that interacts with a touchscreen display of the transaction terminal to perform the first transaction on behalf of a first customer. Again, the transaction can be to: order food, goods, and/or services; make a reservation; perform a check-in at a lodging establishment, and/or purchase goods or services from the establishment.

At 320, the operating mode switcher detects an orientation of the touchscreen display was flipped on the transaction terminal from an original first orientation to a new second orientation.

In an embodiment, at 321, the operating mode switcher receives an event raised by a gyroscope associated with the touchscreen display. The event identifies the orientation of the touchscreen display changing from the first original orientation to the new second orientation. The gyroscope can be integrated into the touchscreen display, a motherboard of the terminal encased in the display, or a pivot lever from which the display is moved or re-oriented.

At 330, the operating mode switcher configures the transaction terminal to perform a second transaction that is capable of being performed by the second customer through interaction by the second customer through interaction by the second customer with the touchscreen display based on the second orientation being detected.

In an embodiment, at 331, the operating mode switcher changes a current cashier-assisted or POS mode of operation for the transaction terminal to a SS or kiosk mode of operation for the transaction terminal based on the second orientation being detected.

In an embodiment of 331 and at 332, the operating mode switcher switches from a first interface associated with the touchscreen display for the current cashier-assisted or POS mode of operation to a second interface associated with the touchscreen display for the SS or kiosk mode of operation.

In an embodiment, at 333, the operating mode switcher changes resource security settings and active peripherals that are accessible from the transaction terminal to the second customer during the second transaction from previous resource security settings and previous active peripherals that were accessible from the transaction terminal to the cashier during the first transaction.

According to an embodiment, at 340, the operating mode switcher detect the orientation of the touchscreen display as flipped back to the first orientation on the transaction terminal. The operating mode switcher configures the transaction terminal to perform a third transaction that is capable of being performed by the cashier (or a different cashier that is now operating the transaction terminal) through interaction with the touchscreen display to perform the third transaction on behalf of a third customer.

In an embodiment of 340 and at 341, the operating mode switcher changes a current SS or kiosk mode of operation for the transaction terminal to a cashier-assisted or POS mode of operation for the transaction terminal based on the first orientation being re-detected.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
detecting a change in orientation of a display associated with a transaction terminal from a first orientation to a second orientation based on an event raised by an accelerometer that is integrated into a motherboard that is mounted on a back of the display within a housing; and
dynamically changing the transaction terminal from a first mode of operation to a second mode of operation based on detection of the second orientation based on processing an Operating System (OS) hook of an OS for the motherboard when the OS detects the event raised by the accelerometer, wherein dynamically changing further includes suspending the first mode of operation when changing to the second mode and processing different programs from what was being processed with the first mode.

2.-3. (canceled)

4. The method of claim 1, wherein dynamically changing further includes identifying the first mode of operation as a cashier-assisted or Point-Of-Sale (POS) mode of operation for the transaction terminal.

5. The method of claim 4, wherein identifying further includes establishing the second mode of operation as a Self-Service (SS) or kiosk mode of operation for the transaction terminal.

6. The method of claim 1, wherein dynamically changing further includes changing first content displayed on the display with the first mode of operation to different content when changing to the second mode of operation.

7. The method of claim 6, wherein dynamically changing further includes changing a first interface presented for interaction on the display with the first mode of operation to a different interface when changing to the second mode of operation.

8. The method of claim 7, wherein dynamically changing further includes changing first operations available from the first interface with the first mode of operation to different operations associated with the different interface when changing to the second mode of operation.

9. The method of claim 1, wherein dynamically changing further includes disabling at least one peripheral interfaced to the transaction terminal ensuring the at least one peripheral is unavailable during the second mode of operation.

10. The method of claim 1, wherein dynamically changing further includes enabling at least one peripheral interfaced to the transaction terminal for the second mode of operation, wherein the at least one peripheral was inactive and disabled during the first mode of operation.

11. The method of claim 1, wherein dynamically changing further includes changing operator security settings for accessing resources of the transaction terminal when changing to the second mode of operation.

12. A method, comprising:
processing, on a transaction terminal, a first transaction based on interactions of a cashier that interacts with a touchscreen display of the transaction terminal to perform the first transaction on behalf of a first customer;
detecting, on the transaction terminal, an orientation of the touchscreen display flipped from a first orientation to a second orientation based on an event raised by an accelerometer that is integrated into a motherboard that is mounted on a back of the touchscreen display within a housing;
suspending first programs on the transaction terminal associated with the interactions of the cashier;
configuring the transaction terminal to perform a second transaction that is capable of being performed by a second customer through interaction by the second customer with the touchscreen display based on the second orientation by processing an Operating System (OS) hook of an OS for the motherboard to perform the configuring when the OS detects the event raised by the accelerometer; and
processing, on the transaction terminal, the second transaction based on second interactions of the second customer by processing second programs on the transaction terminal.

13. The method of claim 12 further comprising:
detecting, on the transaction terminal, the orientation of the touchscreen display was flipped back to the first orientation; and
configuring the transaction terminal to perform a third transaction that is capable of being performed by the cashier through interaction with the touchscreen display to perform the third transaction on behalf of a third customer.

14. The method of claim 13, wherein configuring the transaction terminal to perform the third transaction further includes changing a current self-service or kiosk mode of operation for the transaction terminal to a cashier-assisted mode of operation for the transaction terminal based on the first orientation.

15. (canceled)

16. The method of claim 12, wherein configuring further includes changing a current cashier-assisted mode of operation for the transaction terminal to a self-service or kiosk mode of operation for the transaction terminal based on the second orientation.

17. The method of claim 16, wherein changing further includes switching from a first interface associated with the touchscreen display for the current cashier-assisted mode of operation to a second interface associated with the touchscreen display for the self-service or kiosk mode of operation.

18. The method of claim 12, wherein configuring further includes changing resource security settings and active peripherals that are accessible from the transaction terminal to the second customer during the second transaction from previous resource security settings and previous active peripherals that were accessible from the transaction terminal to the cashier during the first transaction.

19. A transaction terminal, comprising:
a touchscreen display having a motherboard with a processor and an accelerometer integrated into a housing on a backside of the motherboard, wherein the accelerometer is integrated into the motherboard;
a mounting brace having a pivot lever attached to the backside of the touchscreen display;
a base attached to a bottom of the mounting brace;
a non-transitory computer-readable storage medium having executable instructions; and
the executable instruction when executed from the non-transitory computer-readable storage medium by the processor causes the processor to:
receive an event raised by the accelerometer when the touchscreen display was pivoted or flipped from a first orientation to a second orientation using the pivot lever;
suspending first programs being processed on the transaction terminal responsive to the event;
change an interface accessible from the touchscreen display and operations associated with the interface to a second interface and second operations associated with the second interface by processing an Operating System (OS) hook of an OS for the motherboard to change the interface to the second interface when the OS detects the event raised by the accelerometer; and
processing second programs on the transaction terminal associated with the second interface and the second operations.

20. The transaction terminal of claim 19, wherein the mounting brace includes an aperture to house wires running from the motherboard to the base, and wherein the base includes a docketing port to connect: the wires, peripheral devices, power, and network connections to the transaction terminal, wherein the docketing port is encased inside of the base.
